(19) United States
(12) Patent Application Publication
(10) Pub. No.: US 2014/0379463 A1
(43) Pub. Date: Dec. 25, 2014

(54) ADVERTISEMENT DISTRIBUTION MANAGEMENT APPARATUS, ADVERTISEMENT DISTRIBUTION SYSTEM, AND ADVERTISEMENT DISTRIBUTION MANAGEMENT METHOD

(71) Applicant: YAHOO JAPAN CORPORATION, Tokyo (JP)

(72) Inventors: Shinichiro SEGA, Tokyo (JP); Takashi TASHIRO, Tokyo (JP); Naoki ITO, Tokyo (JP); Koji TSUKAMOTO, Tokyo (JP)

(21) Appl. No.: 14/302,804

(22) Filed: Jun. 12, 2014

(30) Foreign Application Priority Data
Jun. 19, 2013 (JP) 2013-128353

(51) Int. Cl. G06Q 30/02

(52) U.S. Cl. CPC G06Q 30/0247
USPC 705/14.46

(57) ABSTRACT

An advertisement distribution management apparatus according to an embodiment includes an estimation unit, an assignment unit, an inquiry unit, and a selection unit. The estimation unit estimates an expected profit value in a case in which advertising content is distributed by a first advertisement distribution apparatus in response to an advertisement request. The assignment unit assigns a price rank to the advertisement request on the basis of the expected profit value. The inquiry unit inquires of one or more second advertisement distribution apparatuses whether to distribute the advertising content at the price rank in response to the advertisement request. The selection unit selects the first advertisement distribution apparatus as a distribution source of the advertising content corresponding to the advertisement request when there is no second advertisement distribution apparatus, in response to the inquiry, which distributes the advertising content at the price rank in response to the advertisement request.

### CROSS-REFERENCE TO RELATED APPLICATIONS

The present application claims priority to and incorporates by reference the entire contents of Japanese Patent Application No. 2013-128353 filed in Japan on Jun. 19, 2013.

### BACKGROUND OF THE INVENTION

1. Field of the Invention

The present invention relates to an advertisement distribution management apparatus, an advertisement distribution system, and an advertisement distribution management method.

2. Description of the Related Art

In recent years, with significant growth of the Internet, advertisement distribution has been frequently performed via the Internet. For example, advertisement distribution is performed by displaying advertising content of a company or a commodity in an advertising space set in an advertising medium (for example, a Web page), and displaying a Web page of an advertiser when such advertising content is clicked.

Examples of a media company having an advertising medium include a media company that consigns sales of remaining inventory of the advertising spaces to an advertisement distributor while selling part of the inventory of the advertising spaces to an advertiser, and a media company that consigns sales of the entire inventory of advertising spaces to the advertisement distributor.

In a case in which a price for placing the advertising content is determined, for example, on the basis of a bidding price designated by an advertiser or advertising effectiveness (for example, CTR: Click Through Rate), a profit of a media company from an advertising space may be increased or decreased depending on whether a distribution source of the advertising content (hereinafter, referred to as an advertisement distribution source) is the media company or the advertisement distributor. Also in a case of consigning the sales of the entire inventory of advertising spaces to a plurality of advertisement distributors, the profit of the media company may be increased or decreased depending on which of the advertisement distributors is the advertisement distribution source.

It is desired for the media company to maximize the profit from the advertising space, and the advertisement distribution source should be appropriately selected. Accordingly, a technique has been developed for improving the profit of the media company by estimating an effective cost per mille (eCPM) for each piece of the advertising content and selecting the advertisement distribution source on the basis of the estimated eCPM (for example, refer to Japanese Patent Application Laid-open No. 2012-093796).

However, the media company cannot acquire information about a unit price for distributing the advertising content (for example, CPC; Cost Per Click) from the advertisement distributor in some cases. In this case, because the eCPM of the advertising content cannot be estimated according to the technique described above, the advertisement distribution source cannot be selected.

### SUMMARY OF THE INVENTION

An advertisement distribution management apparatus according to an embodiment includes a reception unit, an estimation unit, an assignment unit, an inquiry unit and a selection unit. The reception unit receives an advertisement request for requesting distribution of advertising content. The estimation unit estimates an expected profit value in a case in which the advertising content is distributed by a first advertisement distribution apparatus in response to the advertisement request. The assignment unit assigns a price rank to the advertisement request on the basis of the expected profit value. The inquiry unit inquires of one or more second advertisement distribution apparatuses whether to distribute the advertising content at the price rank in response to the advertisement request. The selection unit selects the first advertisement distribution apparatus as a distribution source of the advertising content corresponding to the advertisement request when there is no second advertisement distribution apparatus, in response to the inquiry, which distributes the advertising content at the price rank in response to the advertisement request.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1A is a diagram illustrating advertisement distribution management processing according to an embodiment of the present invention;

FIG. 1B is a diagram illustrating an example of a price condition based on a price condition table;

FIG. 2 is a diagram illustrating a configuration example of an advertisement distribution system according to the embodiment;

FIG. 3 is a diagram illustrating a configuration example of an advertisement distribution management apparatus according to the embodiment;

FIG. 4 is a diagram illustrating an example of the price condition table;

FIG. 5 is a diagram illustrating a relation between an expected profit value and a profit value;

FIG. 6 is a diagram illustrating an example of a relation between expected profit values;

FIG. 7 is a diagram illustrating an example of the price condition table in a case in which a priority is assigned to each of a plurality of advertisement distribution apparatuses;

FIG. 8 is a diagram illustrating an example of the price condition table in a case in which different price ranks are applied to the respective advertisement distribution apparatuses; and

FIG. 9 is a flowchart illustrating an example of information processing of the advertisement distribution management apparatus according to the embodiment.

### DETAILED DESCRIPTION OF THE PREFERRED EMBODIMENTS

The following describes embodiments of an advertisement distribution management apparatus, an advertisement distribution system, an advertisement distribution management method, and an advertisement information management program according to the present application in detail with reference to drawings. The advertisement distribution management apparatus, the advertisement distribution system, the advertisement distribution management method, and the advertisement information management program according to the present application are not limited to the embodiments.

### 1. Advertisement Distribution Processing

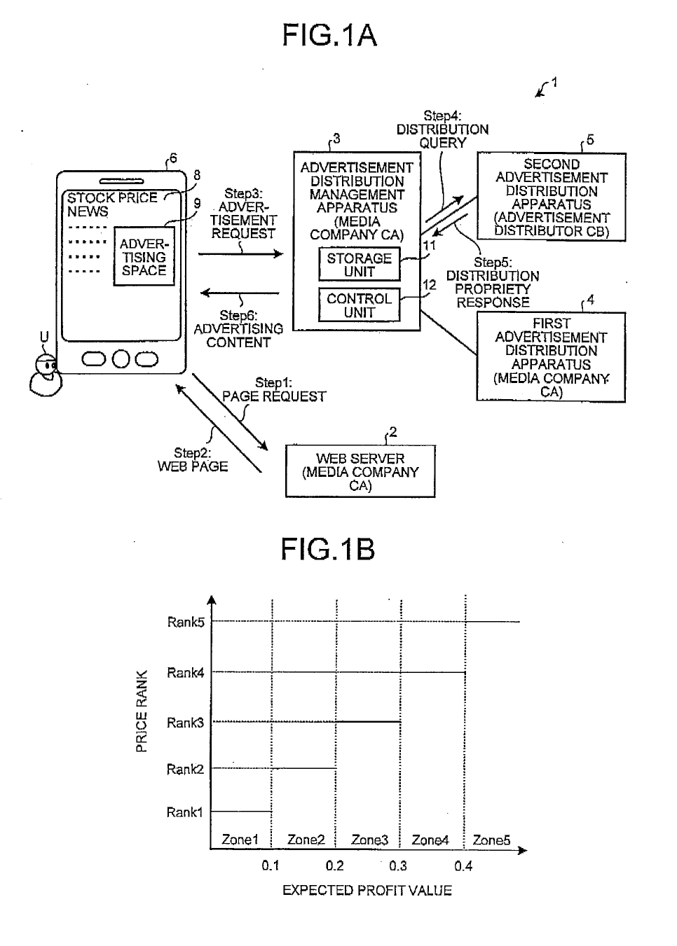

First, the following describes advertisement distribution processing according to the embodiment. FIG. 1A and FIG. 1B are explanatory diagrams illustrating the advertisement distribution processing according to the embodiment, and the advertisement distribution processing is performed by the advertisement distribution system in this embodiment. Hereinafter, a Web page is exemplified as an advertising medium. However, the advertising medium may be any advertising medium other than the Web page. For example, the advertising medium may be a medium using a game application, a book browsing application, a music distribution application, and a moving image distribution application.

As illustrated in FIG. 1A, an advertisement distribution system 1 according to the embodiment includes a Web server 2, an advertisement distribution management apparatus 3, a first advertisement distribution apparatus 4, and a second advertisement distribution apparatus 5, and these devices are connected to each other in a communicable manner via a communication network. The Web server 2, the advertisement distribution management apparatus 3, and the first advertisement distribution apparatus 4 are managed and operated by, for example, a media company CA. The second advertisement distribution apparatus 5 is managed and operated by, for example, an advertisement distributor CB.

The Web server 2 stores therein a plurality of Web pages, and advertising spaces are set to the Web pages. when receiving a page request (Step 1) transmitted from a terminal device 6, the Web server 2 transmits a Web page 8 corresponding to the page request to the terminal device 6 (Step 2).

When receiving the Web page 8 from the Web server 2, the terminal device 6 transmits an advertisement request to the advertisement distribution management apparatus 3 (Step 3). Such an advertisement request is a distribution request for the advertising content to be displayed in an advertising space 9 set to the Web page 8.

When receiving the advertisement request from the terminal device 6, a control unit 12 of the advertisement distribution management apparatus 3 estimates an expected profit value in a case in which the advertising content is distributed by the first advertisement distribution apparatus 4 in response to the advertisement request. The expected profit value is, for example, an effective cost per mille (eCPM) that is expected by distributing the advertising content in response to the advertisement request.

The eCPM is a profit per 1000 impressions. The control unit 12 of the advertisement distribution management apparatus 3 estimates an eCPM expected value, for example, from an attribute of a user U, an attribute of the advertising space 9, and a click frequency or an impression frequency of the advertising content in the past. The eCPM expected value is set, for example, in five stages from “Zone 1” to “Zone 5”.

A storage unit 11 of the advertisement distribution management apparatus 3 stores therein a price condition table for selecting a distribution source of the advertising content corresponding to the advertisement request. FIG. 1B is a diagram illustrating an example of a price condition based on the price condition table stored in the storage unit 11. As illustrated in FIG. 1B, the price condition based on the price condition table represents a relation between the expected profit value with the first advertisement distribution apparatus 4 and the price rank presented by the second advertisement distribution apparatus 5.

In the example illustrated in FIG. 1B, the price rank of “Rank 1” is set when the expected profit value is in “Zone 1”, and the price rank of “Rank 2” is set when the expected profit value is in “Zone 2”. The price rank of “Rank 3” is set when the expected profit value is in “Zone 3”, the price rank of “Rank 4” is set when the expected profit value is in “Zone 4”, and the price rank of “Rank 5” is set when the expected profit value is in “Zone 5”. The price ranks may be provided so as to be proportional to the expected profit values instead of providing the price ranks in a stepwise manner such as from “Rank 1” to “Rank 5”. For example, the price rank may be a result obtained by multiplying the expected profit value by a predetermined coefficient.

The control unit 12 of the advertisement distribution management apparatus 3 determines the price rank to be assigned to the advertisement request (hereinafter, referred to as a provision price rank in some cases) on the basis of the expected profit value with the first advertisement distribution apparatus 4. For example, when the expected profit value with the first advertisement distribution apparatus 4 is in “Zone 2”, the control unit 12 assigns the price rank of “Rank 2” or higher as the provision price rank to the advertisement request.

The provision price rank is preferably set in the price condition table so that the profit that can be obtained by the media company CA from the advertisement distributor CB by selling the inventory of the advertising spaces is equal to or more than the expected profit value with the first advertisement distribution apparatus 4. For example, with respect to the provision price rank, when 50% of the profit obtained from the advertisement distributor CB is provided to the media company CA, 50% of the profit obtained by the advertisement distributor CB is preferably equal to or more than the expected profit value with the first advertisement distribution apparatus 4.

The control unit 12 of the advertisement distribution management apparatus 3 inquires of the second advertisement distribution apparatus 5 whether to distribute the advertising content in response to the advertisement request at the provision price rank assigned to the advertisement request (Step 4). In response to such an inquiry, the control unit 12 receives a response indicating distribution propriety (hereinafter, referred to as a distribution propriety response) from the second advertisement distribution apparatus 5 (Step 5). The control unit 12 of the advertisement distribution management apparatus 3 selects, on the basis of the distribution propriety response, the advertisement distribution apparatus that distributes the advertising content in response to the advertisement request, and causes the selected advertisement distribution apparatus to distribute the advertising content (Step 6).

Specifically, if the distribution propriety response received from the second advertisement distribution apparatus 5 indicates that distribution is enabled, the control unit 12 causes the second advertisement distribution apparatus 5 to distribute the advertising content in response to the advertisement request. On the other hand, if the distribution propriety response received from the second advertisement distribution apparatus 5 indicates that distribution is disabled, there is no second advertisement distribution apparatus 5 that distributes the advertising content in response to the advertisement request at the provision price rank. Accordingly, the control unit 12 causes the first advertisement distribution apparatus 4 to distribute the advertising content in response to the advertisement request.

In this way, when the advertisement can be distributed by the second advertisement distribution apparatus 5 at the provision price rank at which the profit equal to or more than the expected profit value with the first advertisement distribution apparatus 4 can be obtained, the advertisement distribution management apparatus 3 causes the second advertisement distribution apparatus 5 to distribute the advertisement. On the other hand, when the second advertisement distribution apparatus 5 does not distribute the advertisement at the provision price rank, the advertisement distribution management apparatus 3 causes the first advertisement distribution apparatus 4 to distribute the advertisement.

Accordingly, even when it cannot be found which is higher in the profit: the profit from the advertisement distribution with the first advertisement distribution apparatus 4 and the profit from the advertisement distribution with the second advertisement distribution apparatus 5, it is possible to obtain the profit equal to or more than the expected profit value of the first advertisement distribution apparatus 4 and improve the profit from the advertising space.

### 2. Advertisement Distribution System 1

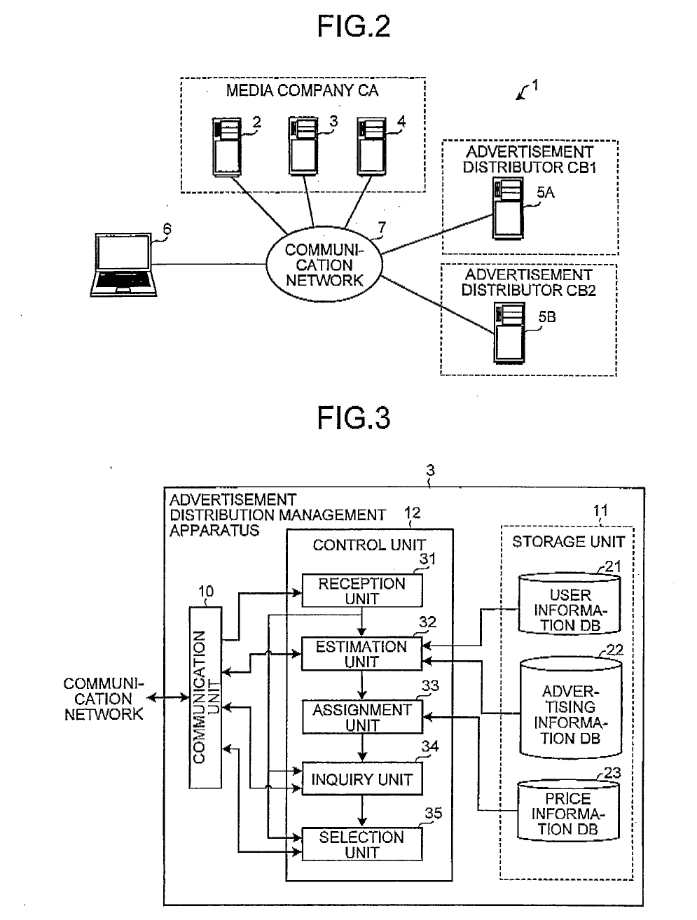

Next, the following describes a configuration example of the advertisement distribution system 1 according to the embodiment with reference to FIG. 2. The following describes an example of a case in which each of a plurality of advertisement distributors has the second advertisement distribution apparatus. The number of the advertisement distributors and the second advertisement distribution apparatuses is not limited to two, and may be three or more.

As exemplified in FIG. 2, the advertisement distribution system 1 according to the embodiment includes the Web server 2, the advertisement distribution management apparatus 3, the first advertisement distribution apparatus 4, and the second advertisement distribution apparatuses 5A and 5B (hereinafter, collectively referred to as the second advertisement distribution apparatus 5 in some cases). These devices are connected to each other in a communicable manner via a communication network 7. The communication network 7 is, for example, the Internet.

The terminal device 6 is, for example, a personal computer (PC), a personal digital assistant (PDA), and a smartphone that are used by the user U, on which a browser application (hereinafter, referred to as a browser) is installed.

The Web server 2 stores therein a plurality of Web pages to which the advertising spaces are set. When there is an access from the browser of the terminal device 6 via the communication network 7, the control unit of the Web server 2 provides the Web page corresponding to a uniform resource locator (URL) designated by the terminal device 6.

When receiving the Web page from the Web server 2, the browser of the terminal device 6 transmits, to the advertisement distribution management apparatus 3, the advertisement request corresponding to the advertising space set to the Web page. The advertisement request is a request for distributing the advertising content to be displayed in the advertising space, and includes, for example, identification information of the user U of the terminal device 6 (hereinafter, referred to as a user ID) and identification information of the advertising space (hereinafter, referred to as an advertising space ID). The user ID is, for example, a HyperText Transfer Protocol Cookie (HTTP cookie: hereinafter, referred to as a B cookie). The B cookie may include user information such as an age or sex of the user U other than the user ID.

The advertisement distribution management apparatus 3 causes any of the first and second advertisement distribution apparatuses 4, 5A, and 5B to distribute the advertising content corresponding to the advertisement request. The first advertisement distribution apparatus 4 is managed and operated by the media company CA, the second advertisement distribution apparatus 5A is managed and operated by an advertisement distributor CB1, and the second advertisement distribution apparatus 5B is managed and operated by an advertisement distributor CB2.

When there is ah inquiry about the advertisement distribution from the advertisement distribution management apparatus 3, the second advertisement distribution apparatus 5 determines whether to perform the advertisement distribution. If it is determined that the advertisement distribution is performed, the second advertisement distribution apparatus 5 transmits a response indicating that distribution is enabled to the advertisement distribution management apparatus 3. If it is determined that the advertisement distribution is not performed, the second advertisement distribution apparatus 5 transmits a response indicating that distribution is disabled to the advertisement distribution management apparatus 3.

The advertisement distribution management apparatus 3 determines the advertisement distribution apparatus for distributing the advertising content corresponding to the advertisement request from among the advertisement distribution apparatuses 4, 5A, and 5B on the basis of the response indicating distribution propriety from the second advertisement distribution apparatus 5, and causes the determined advertisement distribution apparatus to distribute the advertising content.

### 3. Advertisement Distribution Management Apparatus 3

FIG. 3 is a diagram illustrating a configuration example of the advertisement distribution management apparatus 3. As illustrated in FIG. 3, the advertisement distribution management apparatus 3 includes a communication unit 10, the storage unit 11, and the control unit 12.

The communication unit 10 is a communication interface that transmits/receives information to/from the communication network 7, and is connected to the communication network 7 in a wired or wireless manner. The control unit 12 can transmit/receive various pieces of information to/from the first advertisement distribution apparatus 4, the second advertisement distribution apparatuses 5A and 5B, and the terminal device 6 via the communication unit 10 and the communication network 7.

The storage unit 11 includes a user information data base (DB) 21, an advertising space information DB 22, and a price information DB 23. Examples of the user information DB 21, the advertising space information DB 22, and the price information DB 23 include a semiconductor memory device such as a random access memory (RAM) and a flash memory, and a storage device such as a hard disk and an optical disc.

The control unit 12 performs advertisement distribution management processing. The control unit 12 is made, for example, with an integrated circuit such as an application specific integrated circuit (ASIC) or a field programmable gate array (FPGA). The control unit 12 functions as a reception unit 31, an estimation unit 32, an assignment unit 33, an inquiry unit 34, and a selection unit 35 when a program (an example of an advertisement distribution program) stored in an internal storage device is executed in the RAM serving as a working area with an internal central processing unit (CPU) or a micro processing unit (MPU).

The configuration of the control unit 12 is not limited thereto. Other configuration may be employed so long as information processing described later is performed. The advertisement distribution management apparatus 3 includes a reading device (not illustrated). The control unit 12 can implement the functions thereof described above by reading the program recorded in a recording medium via the reading device into the internal storage device and executing the program. Examples of the recording medium include an optical disc, a flexible disk, and a hard disk.

3.1. Reception Unit 31

The reception unit 31 receives the advertisement request from the terminal device 6. The advertisement request includes information about the B cookie and the advertising space ID. The B cookie includes the user ID of the user U. The reception unit 31 outputs the information about the received advertisement request to the estimation unit 32.

3.2. Estimation Unit 32

The estimation unit 32 estimates the expected profit value (hereinafter, referred to as an expected profit value RA) in a case in which the first advertisement distribution apparatus 4 distributes the advertising content in response to the advertisement request, and outputs information about the estimated expected profit value RA to the assignment unit 33. The estimation unit 32 estimates the expected profit value RA, for example, using a statistical technique with an estimation model based on information such as the attribute of the user U and the advertising space.

Examples of the attribute of the user U include an age, sex, a location, and a preference of the user U. Examples of the information about the advertising space include a type, a size, a position in the page, a click frequency, a display frequency, and average display time of the advertising space. The click frequency is a frequency at which the advertising content in the advertising space is clicked during an immediately preceding predetermined period. The display frequency is a frequency at which the advertising content is displayed in the advertising space during the immediately preceding predetermined period. The average display time is average display time in the past of the Web page to which the advertising space is set.

The user information DB 21 stores therein the attribute information such as an age, sex, a location, a preference of the user U in association with the user ID. The estimation unit 32 acquires the attribute information of the user U from the user information DB 21 on the basis of the user ID included in the advertisement request. When the B cookie includes the user attribute, the estimation unit 32 can use the user attribute included in the B cookie for estimating the expected profit value RA.

The advertising space information DB 22 stores therein information such as a type, a size, a position in the page, a click frequency, a display frequency, and average display time of the advertising space in association with the advertising space ID. The estimation unit 32 acquires information about the advertising space from the advertising space information DB 22 on the basis of the advertising space ID included in the advertisement request.

When the expected profit value RA is assumed to be the eCPM expected value, for example, the estimation unit 32 obtains a click through ratio (CTR) expected value and a cost per click (CPC) expected value, and multiplies the CTR expected value by the CPC expected value to obtain the expected profit value RA.

The CTR expected value is an expected value of the CTR for the advertisement request. The estimation unit 32 obtains the CTR expected value using, for example, a support vector machine (SVM) and sigmoid fitting, with a click on the advertising content in the advertising space as a dependent variable and with the attribute information of the user U and the information about the advertising space described above as an independent variable (explanatory variable). The estimation unit 32 can, for example, obtain the CTR expected value through logistic regression analysis.

The CPC expected value is an expected value of the CPC for the advertisement request. The estimation unit 32 obtains the CPC expected value through, for example, multiple regression analysis or Poisson regression analysis, with a unit price for distributing the advertising content serving as a distribution candidate (for example, the CPC or a cost per action (CPA)) for the advertisement request as the dependent variable and with the attribute information of the user U and the information about the advertising space described above as the independent variable (explanatory variable). The advertising content of the distribution candidate for the advertisement request is advertising content distributed by the first advertisement distribution apparatus 4 in response to the advertisement request received by the reception unit 31. The estimation unit 32 inquires of, for example, the first advertisement distribution apparatus 4 about the unit price for distributing the advertising content serving as the distribution candidate for the advertisement request, and acquires the unit price from the first advertisement distribution apparatus 4.

Although the eCPM expected value is the expected profit value per 1000 impressions, the number of units of the impressions is not limited to 1000 impressions. The estimation unit 32 can obtain, for example, the expected profit value per 1 impression or the expected profit value per 10 impressions as the expected profit value RA.

The estimation unit 32 can also obtain the expected profit value RA for the advertisement request using a statistical technique that selectively uses a plurality of estimation models. For example, the estimation unit 32 can obtain the expected profit value RA for the advertisement request using a model corresponding to the B cookie from among an estimation model A, an estimation model B, and a model that is manually optimized (hereinafter, referred to as a manual model) C.

The estimation model A is, for example, an estimation model that estimates the CTR expected value using the SVM and the sigmoid fitting, and estimates the CPC expected value through the multiple regression analysis. The estimation model B is, for example, an estimation model that estimates the CTR expected value through the logistic regression analysis, and estimates the CPC expected value through the Poisson regression analysis.

The estimation unit 32 obtains a hash value by calculating the B cookie using a predetermined hash function, applies the estimation model A when the last one digit of the hash value is 1 to 3, applies the estimation model B when it is 4 to 7, and applies the manual model C in other cases. A method for sorting the model is not limited to the above method. For example, the model may be sorted using the last two digits or the first digit of the hash value, or may be sorted using a character or a numerical of the user ID. The estimation unit 32 does not need to sort the model.

3.3. Assignment Unit 33

The assignment unit 33 acquires information about the expected profit value RA from the estimation unit 32, and assigns the price rank corresponding to the expected profit value RA to the advertisement request. The price information DB 23 stores therein the price condition table, and the assignment unit 33 assigns the price rank corresponding to the expected profit value RA to the advertisement request on the basis of the price condition table.

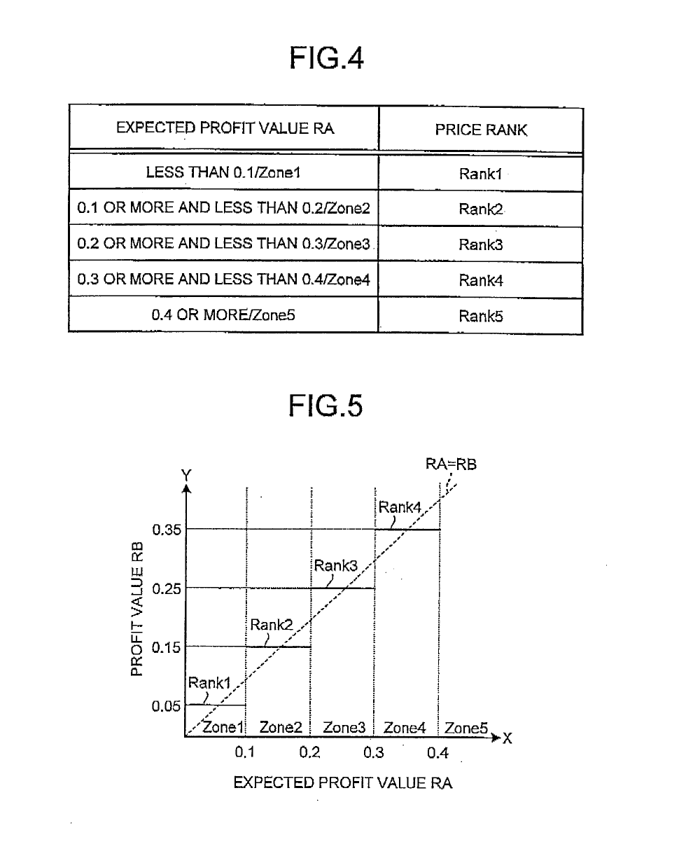

FIG. 4 is a diagram illustrating an example of the price condition table stored in the price information DB 23. The price condition table illustrated in FIG. 4 is information associating a range of the expected profit value RA with the price rank. A first price rank “Rank 1” to a fifth price rank “Rank 5” are associated with the range of the expected profit value RA in a stepwise manner.

When the price condition table is in a state illustrated in FIG. 4, the assignment unit 33 assigns, for example, the first price rank “Rank 1” to the advertisement request in a case in which the expected profit value RA acquired from the estimation unit 32 is in a range of less than 0.1. The assignment unit 33 assigns the second price rank “Rank 2” to the advertisement request in a case in which the expected profit value RA acquired from the estimation unit 32 is in a range of 0.1 or more and less than 0.2.

The assignment unit 33 assigns the third price rank “Rank 3” to the advertisement request in a case in which the expected profit value RA acquired from the estimation unit 32 is in a range of 0.2 or more and less than 0.3. The assignment unit 33 assigns the fourth price rank “Rank 4” to the advertisement request in a case in which the expected profit value RA acquired from the estimation unit 32 is in a range of 0.3 or more and less than 0.4. The assignment unit 33 assigns the fifth price rank “Rank 5” to the advertisement request in a case in which the expected profit value RA acquired from the estimation unit 32 is in a range of 0.4 or more.

Instead of obtaining the expected profit value RA as a numerical value, the estimation unit 32 may obtain information indicating the range of the expected profit value RA (for example, “Zone 1” to “Zone 5”) and output the information to the assignment unit 33. For example, Zone 1 indicates a range in which the expected profit value RA is less than 0.1, Zone 2 indicates a range in which the expected profit value RA is 0.1 or more and less than 0.2, and Zone 3 indicates a range in which the expected profit value RA is 0.2 or more and less than 0.3. Zone 4 indicates a range in which the expected profit value RA is 0.3 or more and less than 0.4, and Zone 5 indicates a range in which the expected profit value RA is 0.4 or more.

In the price condition table illustrated in FIG. 4, the information indicating the range of the expected profit value RA (hereinafter, referred to as Zone information) is also assigned to the price rank. Accordingly, also when the estimation unit 32 outputs the Zone information, the assignment unit 33 can extract the price rank corresponding to the Zone information from the price condition table.

The following describes a method for obtaining the price condition table. The price rank is preferably set to the price condition table so that the profit obtained by the media company CA from the advertisement distributors CB1 and CB2 is equal to or more than the expected profit value RA with the first advertisement distribution apparatus 4. The profit that can be obtained by the media company CA from the advertisement distributors CB1 and CB2 is a profit of predetermined proportion TAC of the profit corresponding to the price rank presented to the advertisement distributors CB1 and CB2. Hereinafter, a value indicating such a profit is described as a profit value RB.

FIG. 5 is a diagram illustrating a relation between the expected profit value RA and the profit value RB. In FIG. 5, the expected profit value RA is on X-axis, the profit value RB is on Y-axis, and the predetermined proportion TAC is assumed to be 0.5. In this case, if the relation between the expected profit value RA and the profit value RB satisfies RA≦RB, the profit that can be obtained by the media company CA from the advertisement distributors CB1 and CB2 is equal to or more than the expected profit value RA with the first advertisement distribution apparatus 4.

In the example illustrated in FIG. 5, the price rank is set so that an average value RAav of the expected profit value RA is equal to the profit value RB for each range of the expected profit value RA. That is, the price rank is set so that the relation between the average value RAav and the profit value RB satisfies RAav=RB.

For example, in “Zone 1”, the average value RAav is 0.05, and “Rank 1” is set as the price rank corresponding to the profit value RB “0.05”. In “Zone 3”, the average value RAav is 0.25, and “Rank 3” is set as the price rank corresponding to the profit value RB “0.25”. Accordingly, in a case in which the advertisement distributors CB1 and CB2 are caused to distribute the advertising content in response to a plurality of advertisement requests, the profit that can be obtained by the media company CA from the advertisement distributors CB1 and CB2 can be equal to or more than the expected profit value RA with the first advertisement distribution apparatus 4.

The price rank may be set such that the relation between the average value RAav and the profit value RB satisfies RAav<RB instead of RAav=RB. In the example illustrated in FIG. 5, the price rank is set in a stepwise manner for each range of the expected profit value RA. Alternatively, different price ranks may be set for respective expected profit values RA so that the relation between the expected profit value RA and the profit value RB satisfies RA≦RB for each advertisement request.

The expected profit value of each of the advertisement distributors CB1 and CB2 may be estimated to assign priority to each of the advertisement distributors CB1 and CB2 on the basis of the estimated expected profit values (hereinafter, referred to as expected profit values RC1 and RC2).

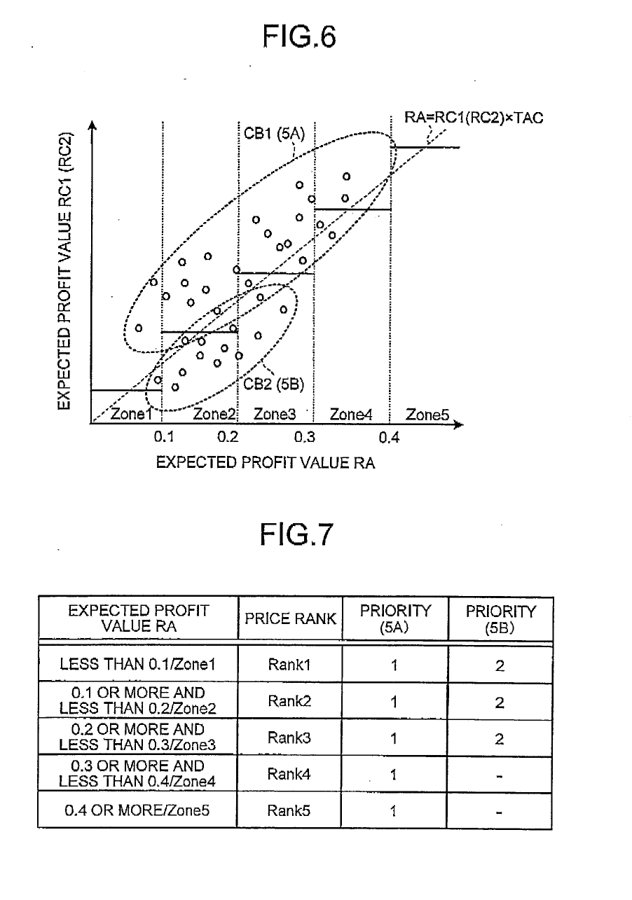

FIG. 6 is a diagram illustrating an example of a relation between the expected profit value RA and the expected profit values RC1 and RC2, and illustrates the relation between the expected profit value RA and the expected profit values RC1 and RC2 for a plurality of advertisement requests. In the example illustrated in FIG. 6, the expected profit value RC1 of the advertisement distributor CB1 is higher as a whole than the expected profit value RC2 of the advertisement distributor CB2.

Accordingly, higher priority is assigned to the second advertisement distribution apparatus 5A corresponding to the advertisement distributor CB1 as compared to the second advertisement distribution apparatus 5B corresponding to the advertisement distributor CB2. The priority represents the order of inquiring by the inquiry unit 34 about the distribution of the advertising content in response to the advertisement request.

FIG. 7 is a diagram illustrating an example of the price condition table in a case in which the priority is assigned to each of the second advertisement distribution apparatuses 5A and 5B. In the price condition table illustrated in FIG. 7, for example, with respect to the ranges “Zone 1” to “Zone 3” of the expected profit value RA, the priority “1” is set to the second advertisement distribution apparatus 5A and the priority “2” is set to the second advertisement distribution apparatus 5B. With respect to the ranges “Zone 4” and “Zone 5” of the expected profit value RA, the priority “1” is set to the second advertisement distribution apparatus 5A but no priority is set to the second advertisement distribution apparatus 5B.

The same price rank is not necessarily applied to the second advertisement distribution apparatuses 5A and 5B. Different price ranks may be applied to the respective second advertisement distribution apparatuses 5A and 5B.

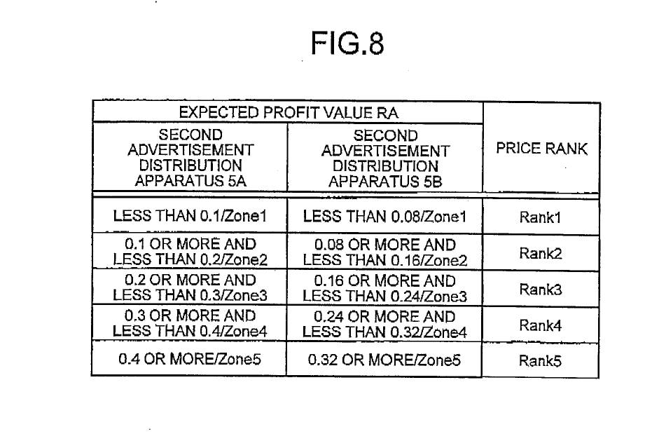

FIG. 8 is a diagram illustrating an example of the price condition table in a case in which different price ranks are applied to the respective second advertisement distribution apparatuses 5A and 5B. In the price condition table illustrated in FIG. 8, the price rank is set on the basis of the expected profit values RC1 and RC2.

For example, corresponding to the price rank “Rank 1”, a range in which the expected profit value RA is less than 0.1 is assigned to the second advertisement distribution apparatus 5A, and a range in which the expected profit value RA is less than 0.08 is set to the second advertisement distribution apparatus 5B. For example, corresponding to the price rank “Rank 2”, a range in which the expected profit value RA is 0.1 or more and less than 0.2 is assigned to the second advertisement distribution apparatus 5A, and a range in which the expected profit value RA is 0.08 or more and less than 0.16 is set to the second advertisement distribution apparatus 5B.

In this way, when advertisement distribution is performed by the advertisement distribution apparatus 5 of which price rank is higher than other devices even though the expected profit values RA thereof are the same, it is possible to improve the profit that can be obtained by the media company CA from the advertisement distributors CB1 and CB2.

The assignment unit 33 outputs the price rank assigned to the advertisement request to the inquiry unit 34. When using the price condition table illustrated in FIG. 7, the assignment unit 33 also outputs information about the priority to the inquiry unit 34. When using the price condition table illustrated in FIG. 8, the assignment unit 33 outputs the price rank for each of the advertisement distributors CB1 and CB2 to the inquiry unit 34.

The assignment unit 33 may also assign the lowest price rank and the highest price rank to the advertisement request. For example, when the price condition table is in the state illustrated in FIG. 4 and the range of the expected profit value RA is “Zone 3”, the lowest price rank is set as the price rank “Rank 3” and the highest price rank is set as the price rank “Rank 5”. In this case, the assignment unit 33 outputs information about the lowest price rank and the highest price rank to the inquiry unit 34.

3.4. Inquiry Unit 34

The inquiry unit 34 inquires of one or more second advertisement distribution apparatuses 5 whether to distribute the advertising content in response to the advertisement request at the provision price rank that is the price rank assigned by the assignment unit 33.

Specifically, the inquiry unit 34 determines the second advertisement distribution apparatus 5 to be inquired, and transmits a distribution query to the determined second advertisement distribution apparatus 5. The distribution query may include, for example, the attribute information of the user U, the information about the advertising space, and the like in addition to the information about the price rank (provision price rank) assigned by the assignment unit 33. The second advertisement distribution apparatus 5 determines whether to distribute the advertising content in response to the advertisement request on the basis of the information included in the distribution query.

When receiving a response, to the distribution query, indicating that distribution is enabled from the second advertisement distribution apparatus 5, the inquiry unit 34 notifies the selection unit 35 of the information about the second advertisement distribution apparatus 5 that has made the response indicating that distribution is enabled. On the other hand, when receiving a response, to the distribution query, indicating that distribution is disabled from the second advertisement distribution apparatus 5, the inquiry unit 34 transmits the distribution query to the second advertisement distribution apparatus 5 to which the distribution query is not transmitted, if any. When receiving the response, to the distribution query, indicating that distribution is enabled from the second advertisement distribution apparatus 5, the inquiry unit 34 notifies the selection unit 35 of the information about the second advertisement distribution apparatus 5 that has made the response indicating that distribution is enabled.

When all of the one or more second advertisement distribution apparatuses 5 to which the distribution query is transmitted make the response indicating that distribution is disabled, the inquiry unit 34 ends inquiry processing, and notifies the selection unit 35 of information indicating that distribution is disabled in all of the second advertisement distribution apparatus 5.

When the provision price rank is assigned on the basis of the price condition table illustrated in FIG. 5, the inquiry unit 34 determines, for example, the second advertisement distribution apparatus 5 to be inquired in predetermined order or randomly, and transmits the distribution query to the determined second advertisement distribution apparatus 5.

When the provision price rank is assigned on the basis of the price condition table illustrated in FIG. 7, the inquiry unit 34 determines the second advertisement distribution apparatus 5 to which the distribution query is transmitted according to the priority output from the assignment unit 33, and transmits the distribution query to the determined second advertisement distribution apparatus 5. The inquiry unit 34 does not transmit the distribution-query to the second advertisement distribution apparatus 5 to which no priority is set.

As illustrated in FIG. 6, the expected profit values RC2 corresponding to the advertisement distributor CB2 concentrate on the ranges “Zone 1” to “Zone 3” of the expected profit value RA, so that there is little possibility of distributing the advertising content in response to the advertisement request at the price ranks “Rank 4” and “Rank 5”. Accordingly, the priority is not set to the price ranks with little possibility of distributing the advertising content so that the inquiry is not made by the inquiry unit 34. This enables the selection unit 35 to speedily select the advertisement distribution apparatus.

When the provision price rank is assigned on the basis of the price condition table illustrated in FIG. 8, the inquiry unit 34 determines the second advertisement distribution apparatus 5 according to the price rank output from the assignment unit 33, and transmits the distribution query to the determined second advertisement distribution apparatus 5. For example, when the expected profit value RA is “0.25”, the price rank of the second advertisement distribution apparatus 5A is “Rank 3” and the price rank of the second advertisement distribution apparatus 5B is “Rank 4”. In this case, the inquiry unit 34 preferentially transmits the distribution query to the second advertisement distribution apparatus 5B.

When the lowest price rank and the highest price rank are assigned by the assignment unit 33, the inquiry unit 34 first makes an inquiry causing the highest price rank to be included in the distribution query as the provision price rank. Unless the response indicating that distribution is enabled is acquired from the second advertisement distribution apparatus 5, the inquiry unit 34 continues to transmit the distribution queries while lowering the provision price rank one by one until the provision price rank reaches the lowest price rank.

For example, when the highest price rank is the price rank “Rank 5” and the lowest price rank is the price rank “Rank 3”, the inquiry unit 34 transmits the distribution queries while lowering the provision price rank in the order of “Rank 5”→“Rank 4”→“Rank 3”. When the highest price rank and the lowest price rank are set to the second advertisement distribution apparatuses 5A and 5B, respectively, the inquiry unit 34 transmits the distribution query to the second advertisement distribution apparatus 5 in sequential order as per provision price rank from the highest to the lowest.

3.5. Selection Unit 35

On the basis of the information notified from the inquiry unit 34, the selection unit 35 determines the advertisement distribution apparatus to be the distribution source of the advertising content corresponding to the advertisement request (hereinafter, referred to as a distribution source advertisement distribution apparatus) from among the advertisement distribution apparatuses 4, 5A, and 5B.

Specifically, when acquiring, from the inquiry unit 34, the information about the second advertisement distribution apparatus 5 that has made the response indicating that distribution is enabled, the selection unit 35 determines the second advertisement distribution apparatus 5 that has made the response indicating that distribution is enabled as the distribution source advertisement distribution apparatus. When acquiring, from the inquiry unit 34, information indicating that distribution is disabled in all of the second advertisement distribution apparatuses 5, the selection unit 35 determines the first advertisement distribution apparatus 4 as the distribution source advertisement distribution apparatus.

After determining the distribution source advertisement distribution apparatus, the selection unit 35 causes the determined distribution source advertisement distribution apparatus to distribute the advertising content in response to the advertisement request. For example, the selection unit 35 requests the distribution source advertisement distribution apparatus to transmit the advertising content, acquires the advertising content corresponding to the advertisement request from the distribution source advertisement distribution apparatus, and transmits the advertising content to the terminal device 6 that has made the advertisement request.

The selection unit 35 may transmit, for example, a URL of the distribution source advertisement distribution apparatus to the terminal device 6 that has made the advertisement request to cause the terminal device 6 to transmit the advertisement request to the distribution source advertisement distribution apparatus. The selection unit 35 may request, for example, the distribution source advertisement distribution apparatus to transmit the advertising content to cause the distribution source advertisement distribution apparatus to transmit the advertising content corresponding to the advertisement request to the terminal device 6 that has made the advertisement request.

In this way, when there is no second advertisement distribution apparatus 5 that distributes the advertising content in response to the advertisement request at the provision price rank, the selection unit 35 selects the first advertisement distribution apparatus 4 as the distribution source of the advertising content corresponding to the advertisement request. Accordingly, the profit from the advertising space can be improved by setting the price rank at which the profit equal to or more than the expected profit value RA with the first advertisement distribution apparatus 4 can be obtained.

### 4. Processing Flow of Advertisement Distribution Management Apparatus 3

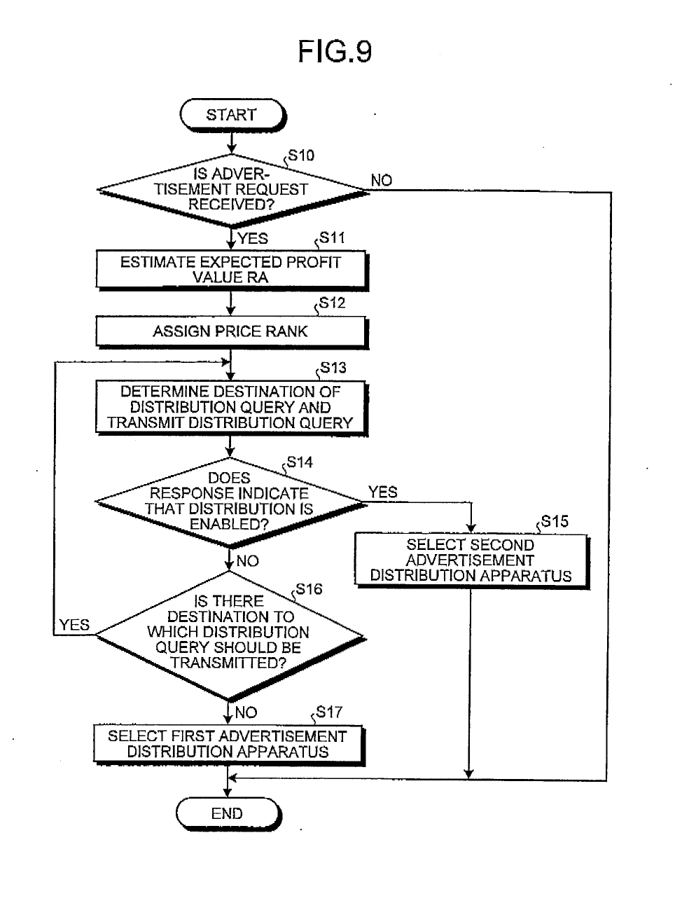

Next, the following describes a procedure of information processing of the advertisement distribution management apparatus 3 according to the embodiment. FIG. 9 is a flowchart illustrating an example of information processing of the advertisement distribution management apparatus 3 according to the embodiment. Such processing is repeatedly performed with the control unit 12 of the advertisement distribution management apparatus 3.

As illustrated in FIG. 9, the control unit 12 of the advertisement distribution management apparatus 3 first determines whether the advertisement request from the terminal device 6 is received (Step S10). If it is determined that the advertisement request is received (Yes at Step S10), the control unit 12 receives the advertisement request and estimates the expected profit value RA corresponding to the advertisement request (Step S11).

Next, the control unit 12 determines the price rank corresponding to the expected profit value RA on the basis of the price condition table stored in the price information DB 23, and assigns the price rank corresponding to the expected profit value RA to the advertisement request as the provision price rank (Step S12).

Next, the control unit 12 determines a destination of the distribution query, and transmits the distribution query including the provision price rank to the determined destination (Step S13). Specifically, the control unit 12 transmits the distribution query to the second advertisement distribution apparatus 5A when the second advertisement distribution apparatus 5A is determined as the destination, and transmits the distribution query to the second advertisement distribution apparatus 5B when the second advertisement distribution apparatus 5B is determined as the destination.

Next, in response to the distribution query transmitted at Step S13, the control unit 12 determines whether the response indicating that distribution is enabled is received from the second advertisement distribution apparatus 5 (Step S14). If it is determined that the response indicating that distribution is enabled is received (Yes at Step S14), the control unit 12 selects the second advertisement distribution apparatus 5 as the distribution source advertisement distribution apparatus (Step S15).

Specifically, the control unit 12 selects the second advertisement distribution apparatus 5A as the distribution source advertisement distribution apparatus when receiving the response indicating that distribution is enabled from the second advertisement distribution apparatus 5A, and selects the second advertisement distribution apparatus 5B as the distribution source advertisement distribution apparatus when receiving the response indicating that distribution is enabled from the second advertisement distribution apparatus 5B.

On the other hand, if it is determined that the response indicating that distribution is disabled is received at Step S14 (No at Step S14), the control unit 12 determines whether there is a destination to which the distribution query should be transmitted (Step S16). For example, in a case in which the second advertisement distribution apparatuses 5A and 5B are transmission targets of the distribution query and the distribution query is not transmitted to the second advertisement distribution apparatus 5B, the control unit 12 determines that there is the second advertisement distribution apparatus 5B as the destination to which the distribution query should be transmitted.

If it is determined that there is the destination to which the distribution query should be transmitted (Yes at Step S16), the control unit 12 returns the process to Step S13. On the other hand, if it is determined that there is no destination to which the distribution query should be transmitted (No at Step S16), the control unit 12 selects the first advertisement distribution apparatus 4 as the distribution source advertisement distribution apparatus (Step S17).

If the process at Step S15 or Step S17 is ended or it is determined that the advertisement request is not received at Step S10 (No at Step S10), the control unit 12 ends the process.

### 5. Other Embodiments

In the above embodiment, the first advertisement distribution apparatus 4 is assumed to be managed and operated by the media company CA. However, the first advertisement distribution apparatus 4 may be managed and operated by an advertisement distributor other than the media company CA as long as it is possible to acquire the expected profit value RA with the first advertisement distribution apparatus 4.

In the above embodiment, the control unit 12 of the advertisement distribution management apparatus 3 requests the distribution source advertisement distribution apparatus to transmit the advertising content. However, it is sufficient that the distribution source advertisement distribution apparatus consequently transmits the advertising content in response to the advertisement request.

In the above embodiment, the attribute information of the user U and the information about the advertising space are included as the information from the advertisement distribution management apparatus 3 to the second advertisement distribution apparatus 5. However, these pieces of information may be acquired by the second advertisement distribution apparatus 5 using other method. For example, a Web beacon may be set to the Web page as the advertising medium so as to be transmitted to the second advertisement distribution apparatus 5. In this case, the second advertisement distribution apparatus 5 acquires the attribute information of the user U from the B cookie included in the Web beacon. By setting the Web beacon to the Web page so that the advertisement request includes the size of the advertising space and the information about a position in the page, the second advertisement distribution apparatus 5 can acquire the information about the advertising space from the Web beacon.

In the above embodiment, the description is made separately for the case of adding the priority and the case of setting the price rank for each second advertisement distribution apparatus 5. However, the priority may be added and the price rank may also be set for each second advertisement distribution apparatus 5. In this case, the second advertisement distribution apparatus 5 of which price rank is high is prioritized. When the price rank is the same, the second advertisement distribution apparatus 5 with high priority is prioritized.

The control unit 12 of the advertisement distribution management apparatus 3 may calculate the expected profit value with the second advertisement distribution apparatuses 5A and 5B on the basis of report data of track record profit that is periodically (for example, monthly) provided from the advertisement distributors CB1 and CB2, and may generate the price condition table.

### 6. Effects

The advertisement distribution management apparatus 3 according to the embodiment includes the reception unit 31, the estimation unit 32, the assignment unit 33, the inquiry unit 34, and the selection unit 35. The reception unit 31 receives the advertisement request for requesting distribution of the advertising content. The estimation unit 32 estimates the expected profit value RA in a case in which the advertising content is distributed by the first advertisement distribution apparatus 4 in response to the advertisement request. The assignment unit 33 assigns the provision price rank to the advertisement request on the basis of the expected profit value RA. The inquiry unit 34 inquires of one or more second advertisement distribution apparatuses 5 (5A, 5B) whether to distribute the advertising content at the provision price rank in response to the advertisement request. According to the result of inquiry, when there are no second advertisement distribution apparatuses 5 (5A, 5B) that distribute the advertising content at the provision price rank in response to the advertisement request, the selection unit 35 selects the first advertisement distribution apparatus 4 as the distribution source of the advertising content corresponding to the advertisement request.

With this configuration, when there is the second advertisement distribution apparatus 5 that distributes the advertising content at the provision price rank in response to the advertisement request, the second advertisement distribution apparatus 5 can be selected as the distribution source of the advertising content corresponding to the advertisement request. Accordingly, the profit from the advertising space can be improved by setting the price rank at which the profit equal to or more than the expected profit value RA with the first advertisement distribution apparatus 4 can be obtained.

The provision price rank is set in a stepwise manner, from the first price rank to the n-th price rank (n is an integer of 2 or more), corresponding to magnitude of the expected profit value RA. The assignment unit 33 assigns, to the advertisement request, the price rank corresponding to the magnitude of the expected profit value RA from among the first price rank to the n-th price rank.

With this configuration, setting of the price rank is prevented from being complicated, and pricing for the advertisement distributors CB1 and CB2 can be simplified. In addition, even when the accuracy of the expected profit value RA is low, dispersion can be absorbed by averaging and the profit from the advertising space can be improved with stability.

The advertisement distribution management apparatus 3 includes the price information DB 23 (an example of a priority storage unit) that stores therein the information about the priority assigned to the second advertisement distribution apparatuses 5A and 5B for each price rank. The inquiry unit 34 preferentially makes an inquiry to the second advertisement distribution apparatus 5 with high priority among the second advertisement distribution apparatuses 5A and 5B.

Accordingly, by giving high priority to the second advertisement distribution apparatus 5 with high possibility of transmitting the response indicating that distribution is enabled, it is possible to uniformly accelerate the distribution of the advertising content in response to the advertisement request.

The advertisement distribution management apparatus 3 includes the price information DB 23 (an example of a price information storage unit) that stores therein information specifying the relation between the expected profit value RA and the price rank for each of the second advertisement distribution apparatuses 5A and 5B. The assignment unit 33 assigns the provision price rank corresponding to the expected profit value RA to each of the second advertisement distribution apparatuses 5A and 5B in response to the advertisement request. The inquiry unit 34 preferentially makes an inquiry to the second advertisement distribution apparatus 5 of which provision price rank is relatively high among the second advertisement distribution apparatuses 5A and 5B.

Accordingly, when advertisement distribution is performed by the advertisement distribution apparatus 5 of which price rank is higher than other devices even though the expected profit values RA thereof are the same, it is possible to improve the profit that can be obtained by the media company CA from the advertisement distributors CB1 and CB2.

The estimation unit 32 has a plurality of types of estimation models for estimating the expected profit value RA, and estimates the expected profit value RA by changing the estimation models corresponding to the terminal device 6 (an example of a client) that makes an advertisement request.

With this configuration, the expected profit value RA can be estimated by using a plurality of estimation models and it is possible to average the dispersion in the estimation of the expected profit value RA with the estimation model.

### 7. Others

The configuration of the advertisement distribution management apparatus 3 described above can be flexibly modified. The advertisement distribution management apparatus 3 may be made with a plurality of server computers, and some functions thereof may be implemented by calling an external platform and the like with an application programming interface (API) or network computing. The advertisement distribution management apparatus 3 and the first advertisement distribution apparatus 4 may be made with one server computer.

According to an aspect of the embodiment, it is possible to provide the advertisement distribution management apparatus, the advertisement distribution system, the advertisement distribution management method, and the advertisement information management program that can improve the profit from the advertising space.

What is claimed is:

1. An advertisement distribution management apparatus comprising:
a reception unit configured to receive an advertisement request for requesting distribution of advertising content;
an estimation unit configured to estimate an expected profit value in a case in which the advertising content is distributed by a first advertisement distribution apparatus in response to the advertisement request;
an assignment unit configured to assign a price rank to the advertisement request on the basis of the expected profit value;
an inquiry unit configured to inquire of one or more second advertisement distribution apparatuses whether to distribute the advertising content at the price rank in response to the advertisement request; and
a selection unit configured to select the first advertisement distribution apparatus as a distribution source of the advertising content corresponding to the advertisement request when there is no second advertisement distribution apparatus, in response to the inquiry, which distributes the advertising content at the price rank in response to the advertisement request.

2. The advertisement distribution management apparatus according to claim 1, wherein
the price rank is set in a stepwise manner, from the first price rank to the n-th price rank (n is an integer of 2 or more), corresponding to magnitude of the expected profit value, and
the assignment unit assigns, to the advertisement request, a price rank corresponding to the magnitude of the expected profit value from among the first price rank to the n-th price rank.

3. The advertisement distribution management apparatus according to claim 2, further comprising:
a priority storage unit configured to store therein information about priority assigned to the second advertisement distribution apparatuses for each price rank, wherein
the inquiry unit preferentially makes the inquiry to the second advertisement distribution apparatus with high priority among the second advertisement distribution apparatuses.

4. The advertisement distribution management apparatus according to claim 2, further comprising:
a price information storage unit configured to store therein information specifying a relation between an expected profit value and a price rank for each of the second advertisement distribution apparatuses, wherein
the assignment unit assigns the price rank corresponding to the expected profit value to each of the second advertisement distribution apparatuses in response to the advertisement request, and
the inquiry unit preferentially makes the inquiry to the second advertisement distribution apparatus of which price rank is relatively high among the second advertisement distribution apparatuses.

5. The advertisement distribution management apparatus according to claim 1, wherein the estimation unit has a plurality of types of estimation models for estimating the expected profit value and estimates the expected profit value on the basis of the estimation models corresponding to a client that makes the advertisement request.

6. An advertisement distribution system comprising:
a first advertisement distribution apparatus configured to distribute advertising content;
a second advertisement distribution apparatus configured to distribute advertising content; and
an advertisement distribution management apparatus that causes any of the first and the second advertisement distribution apparatuses to distribute advertising content corresponding to an advertisement request, wherein
the advertisement distribution management apparatus comprises:
a reception unit configured to receive an advertisement request for requesting distribution of advertising content;
an estimation unit configured to estimate an expected profit value in a case in which the advertising content is distributed by the first advertisement distribution apparatus in response to the advertisement request;
an assignment unit configured to assign a price rank to the advertisement request on the basis of the expected profit value;
an inquiry unit configured to inquire of one or more second advertisement distribution apparatuses whether to distribute the advertising content at the price rank in response to the advertisement request; and
a selection unit configured to select the first advertisement distribution apparatus as a distribution source of the advertising content corresponding to the advertisement request when there is no second advertisement distribution apparatus, in response to the inquiry, which distributes the advertising content at the price rank in response to the advertisement request.

7. An advertisement distribution management method executed by a computer, the advertisement distribution management method comprising:
receiving an advertisement request for requesting distribution of advertising content;
estimating an expected profit value in a case in which advertising content is distributed by a first advertisement distribution apparatus in response to the advertisement request;
assigning a price rank to the advertisement request on the basis of the expected profit value;
inquiring of one or more second advertisement distribution apparatuses whether to distribute advertising content at the price rank in response to the advertisement request; and
selecting the first advertisement distribution apparatus as a distribution source of the advertising content corresponding to the advertisement request when there is no second advertisement distribution apparatus, in response to the inquiry, which distributes the advertising content at the price rank in response to the advertisement request.

8. The advertisement distribution management method according to claim 7, wherein
the price rank is set in a stepwise manner, from the first price rank to the n-th price rank (n is an integer of 2 or more), corresponding to magnitude of the expected profit value, and
the assigning includes assigning, to the advertisement request, a price rank corresponding to the magnitude of the expected profit value from among the first price rank to the n-th price rank.

9. The advertisement distribution management method according to claim 8, further comprising:
storing information about priority assigned to the second advertisement distribution apparatuses for each price rank in a priority storage unit, wherein
the inquiring includes preferentially making the inquiry to the second advertisement distribution apparatus with high priority among the second advertisement distribution apparatuses.

10. The advertisement distribution management method according to claim 8, further comprising:
storing information specifying a relation between an expected profit value and a price rank for each of the second advertisement distribution apparatuses in a price information storage unit, wherein
the assigning includes assigning the price rank corresponding to the expected profit value to each of the second advertisement distribution apparatuses in response to the advertisement request, and
the inquiring includes preferentially making the inquiry to the second advertisement distribution apparatus of which price rank is relatively high among the second advertisement distribution apparatuses.

11. The advertisement distribution management method according to claim 7, wherein
the estimating includes estimating the expected profit value on the basis of an estimation model corresponding to a client that makes the advertisement request from among a plurality of types of estimation models for estimating the expected profit value.

12. A computer readable storage medium containing program instructions for managing an advertisement distribution, wherein execution of the program instructions by one or more processors of a computer system causes the one or more processors to perform:
receiving an advertisement request for requesting distribution of advertising content;
estimating an expected profit value in a case in which advertising content is distributed by a first advertisement distribution apparatus in response to the advertisement request;
assigning a price rank to the advertisement request on the basis of the expected profit value;
inquiring of one or more second advertisement distribution apparatuses whether to distribute advertising content at the price rank in response to the advertisement request; and
selecting the first advertisement distribution apparatus as a distribution source of the advertising content corresponding to the advertisement request when there is no second advertisement distribution apparatus, in response to the inquiry, which distributes the advertising content at the price rank in response to the advertisement request.
